(19) United States
(12) Patent Application Publication
(10) Pub. No.: US 2016/0043373 A1
(43) Pub. Date: Feb. 11, 2016

(54) LITHIUM-ION SECONDARY CELL AND METHOD FOR MANUFACTURING SAME

(71) Applicant: HITACHI AUTOMOTIVE SYSTEMS, LTD., Hitachinaka-shi, Ibaraki (JP)

(72) Inventors: Yasuo ARISHIMA, Hitachinaka-shi (JP); Takuro TSUNAKI, Hitachinaka-shi (JP)

(73) Assignee: HITACHI AUTOMOTIVE SYSTEMS, LTD., Hitachinaka-shi, Ibaraki (JP)

(21) Appl. No.: 14/781,490

(22) PCT Filed: Apr. 1, 2013
(86) PCT No.: PCT/JP2013/059905

§ 371 Date: Sep. 30, 2015

(51) Int. Cl. H01M 2/16; H01M 4/04; H01M 10/0525

(52) U.S. Cl. CPC H01M 2/1673; H01M 10/0525; H01M 4/0404; H01M 2004/028

(57) ABSTRACT

A lithium ion secondary battery includes a flat-shaped electrode group in which separators are interposed between a positive electrode and a negative electrode. The positive electrode has a positive electrode collector, a positive electrode mixture layer formed on a top surface of the positive electrode collector, and an insulating layer formed on the top surface of the positive electrode collector along an end portion of the positive electrode mixture layer. Further, a mixed layer, formed by mixing of a positive electrode mixture configuring the positive electrode mixture layer, and an insulator configuring the insulating layer, is interposed between the positive electrode mixture layer and the insulating layer.

### TECHNICAL FIELD

The present invention relates to a lithium ion secondary battery, and relates to, for example, a lithium ion secondary battery to be used in a power supply of a motive power for an electric car, a hybrid electric car or the like, and a method of manufacturing the same.

### BACKGROUND ART

Recently, there has been a demand for a battery that has a long service life with high energy density, and further, is excellent in input and output characteristics as a power supply of a motive power for an electric car, a hybrid electric car, or the like. In addition, from a viewpoint of placing emphasis on environmental performance, cars have been oriented to traveling using the battery, and accordingly, the battery having a large capacity has been demanded.

The lithium ion secondary battery includes a negative electrode that uses a carbonaceous material or the like into or from which a lithium ion can be inserted or desorbed as an active material, a positive electrode that uses lithium transition metal composite oxide into or from which a lithium ion can be inserted or desorbed as an active material, and a microporous separator made of a resin film. In a wound type lithium ion secondary battery, the negative electrode and the positive electrode are wound with the separator interposed therebetween to form an electrode group (winding group), and the electrode group is housed in a container such as a metal casing (for example, PTL 1).

In addition, such a lithium ion secondary battery has high voltage and high energy, and thus, has a possibility of emitting high temperature heat when an internal short-circuit, which causes the positive electrode and the negative electrode to be in contact with each other, occurs in the state of being charged. Thus, a method of disposing an insulating coating film in an electrode end portion has been suggested in order to prevent the internal short-circuit when the separator is contracted by heat (for example, PTL 2).

### CITATION LIST

### Patent Literatures

PTL 1: JP 9-199114 A

PTL 2: JP 2004-95382 A

### SUMMARY OF INVENTION

### Technical Problem

As described above, the method of disposing an insulating layer in the electrode end portion has been suggested in order to prevent the internal short-circuit that causes the positive electrode and the negative electrode to be in contact with each other in the lithium ion secondary battery. However, there is a problem that the insulating layer is peeled off from an electrode mixture layer or a gap is generated between the insulating layer and the electrode mixture layer due to insufficient adhesion strength of the insulating layer with respect to the electrode mixture layer.

The present invention provides a lithium ion secondary battery capable of avoiding generation of an internal short-circuit by sufficiently securing adhesion strength of an insulating layer with respect to an electrode mixture layer, and further, preventing generation of a gap between the insulating layer and the electrode mixture layer, and a method of manufacturing the same.

### Solution to Problem

A lithium ion secondary battery according to the present invention has characteristics as follows:

A lithium ion secondary battery including an electrode group in which a separator is interposed between a positive electrode and a negative electrode, wherein the positive electrode has a positive electrode collector, a positive electrode mixture layer formed on a top surface of the positive electrode collector, and an insulating layer formed on the top surface of the positive electrode collector along an end portion of the positive electrode mixture layer, and a mixed layer, formed by mixing of a positive electrode mixture configuring the positive electrode mixture layer, and an insulator configuring the insulating layer, is interposed between the positive electrode mixture layer and the insulating layer.

### Advantageous Effects of Invention

According to the configuration described above, it is possible to sufficiently secure the adhesion strength of the insulating layer with respect to the mixture layer due to an anchor effect caused by a mixed layer, and is also possible to prevent generation of the gap between the insulating layer and the mixture layer. Accordingly, it is possible to avoid generation of the internal short-circuit. Incidentally, Problems, configurations, and effects other than the above descriptions will be more apparent through the following description of embodiments.

### BRIEF DESCRIPTION OF DRAWINGS

FIG. 1 is an exploded perspective view of a flat-shaped wound-electrode group of a lithium ion secondary battery which is an embodiment of the present invention.

FIG. 2 is an exploded perspective view of the lithium ion secondary battery which is an embodiment of the present invention.

FIG. 3 is an exterior perspective view of the lithium ion secondary battery which is an embodiment of the present invention.

FIG. 4 is a flowchart of a battery manufacturing process of the lithium ion secondary battery which is an embodiment of the present invention.

FIG. 5 is a schematic view illustrating a main portion of a positive electrode in Example of the present invention regarding the lithium ion secondary battery which is an embodiment of the present invention.

FIG. 6 is a schematic cross-sectional view describing a configuration of an electrode mixture layer, an insulating layer, and a mixed layer of the positive electrode.

FIGS. 7 (a) to 7 (c) are diagrams describing a method by which the mixed layer is formed.

### DESCRIPTION OF EMBODIMENTS

A lithium ion secondary battery includes an electrode group in which a separator is interposed between a negative electrode and a positive electrode. In the positive and negative electrodes, mixture layer (active material mixture layer) is formed on a top surface of a metal foil, which is to be a collector. The mixture layer is formed by coating the top surface of the metal foil with a mixture containing an active material. However, the mixture is not coated on a partial region portion of the metal foil, and the mixture layer is not formed on the portion. The region portion on which the mixture layer is not formed exposes the metal foil, and is called an uncoated portion. Further, a portion on which the mixture layer is formed is called a mixture coated portion. A collector tab for collecting current from an electrode is formed along a side at which the uncoated portion is provided. The positive and negative electrodes are produced in this manner, and have the mixture coated portion, the uncoated portion, and the collector tab formed in the uncoated portion.

In the lithium ion secondary battery according to the present invention, a strip-shaped insulating layer made of an insulator is disposed on a boundary portion between a positive electrode mixture layer formed by partially coating a top surface of a positive electrode collector with a positive electrode mixture, and the uncoated portion which is a region which is not coated with the positive electrode mixture on the top surface of the positive electrode collector, and in the vicinity of the boundary portion. The insulating layer is provided along a boundary portion between the mixture coated portion and the uncoated portion, and is formed on the top surface of the positive electrode collector along an end portion of the positive electrode mixture layer. The strip-shaped insulating layer is formed a partial mixed layer together with the positive electrode mixture layer, and there is no gap between the positive electrode mixture layer and the insulating layer. That is, the mixed layer in which the positive electrode mixture and the insulator are mixed is interposed between the positive electrode mixture layer and the insulating layer.

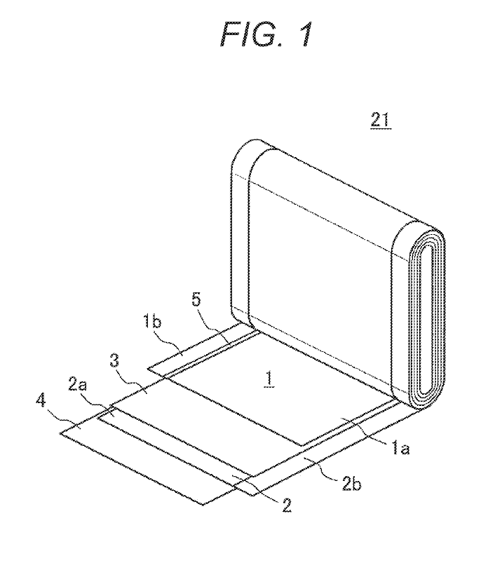

Hereinafter, a description will be made regarding embodiments of the lithium ion secondary battery and a method of manufacturing the same according to the present invention with reference to FIGS. 1 to 7(c).

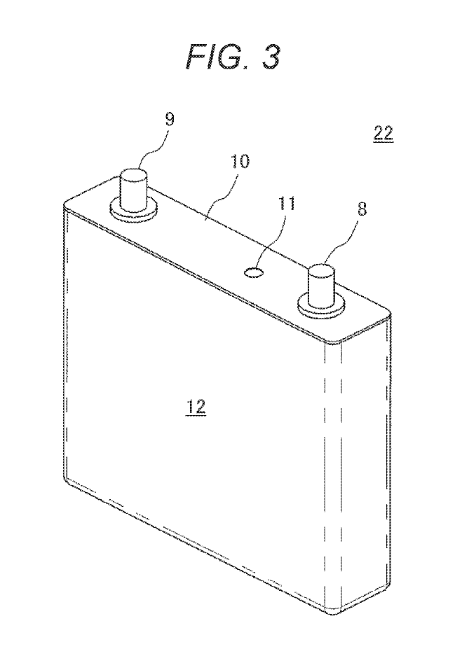

FIG. 3 is an exterior perspective view of a lithium ion secondary battery which is an embodiment of the present invention.

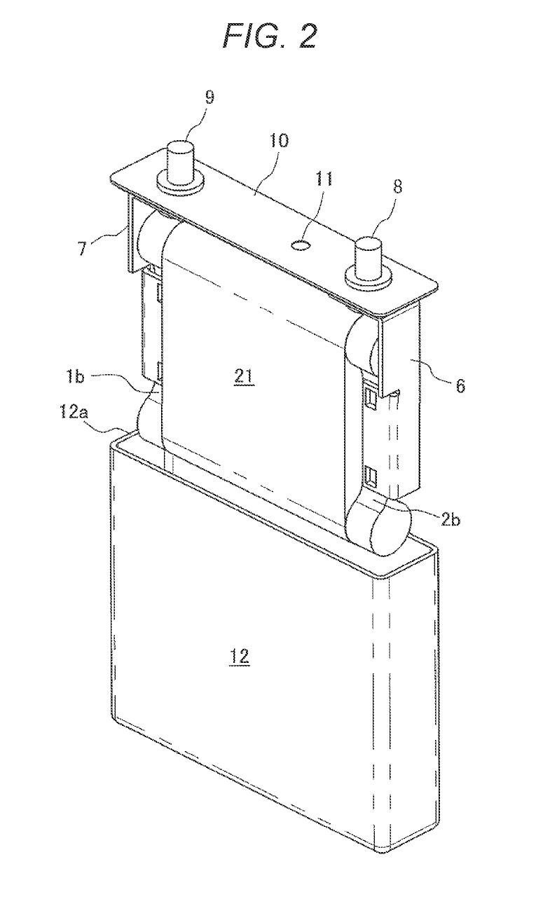

A lithium ion secondary battery 22 is a so-called prismatic battery, and has a battery container 12 formed in a flat box shape by deep-drawing, and a rectangular battery cover 10 that seals an upper opening 12a (See FIG. 2) of the battery container 12. A positive electrode external terminal 9 and a negative electrode external terminal 8 are provided in the battery cover 10. Further, a solution injection port 11 is provided in an intermediate position between the positive electrode external terminal 9 and the negative electrode external terminal 8 of the battery cover 10 so as to inject an electrolyte into the battery container 12 after welding the battery cover 10 to the battery container 12 to perform the sealing.

FIG. 2 is an exploded perspective view of the lithium ion secondary battery.

Each of the negative electrode external terminal 8 and the positive electrode external terminal 9 is attached to the battery cover 10 in the state of penetrating through the battery cover 10 and having a part protruding to a back side of the battery cover 10. Further, a negative electrode collector plate 6 is connected to the negative electrode external terminal 8 in the state of being electrically conducted, and a positive electrode collector plate 7 is connected to the positive electrode external terminal 9 in the state of being electrically conducted. The positive electrode collector plate 7 is bonded to an positive electrode uncoated portion 1b of a flat-shaped wound-electrode group 21 using ultrasonic welding, and the negative electrode collector plate 6 is bonded to an negative electrode uncoated portion 2b of the flat-shaped wound-electrode group 21 using ultrasonic welding. The flat-shaped wound-electrode group 21 is housed in the battery container 12 in a state in which both end portions in an axial direction of winding thereof are suspended from the battery cover 10 and supported by the positive electrode collector plate 7 and the negative electrode collector plate 6. The battery cover 10 is bonded to the battery container 12 in the state of occluding the upper opening 12a of the battery container 12 using laser welding, thereby sealing the upper opening 12a of the battery container 12.

The lithium ion secondary battery 22 is completed by sealing the solution injection port 11 after injecting, into the battery container 12, a predetermined amount of a non-aqueous electrolyte that can infiltrate into the entire the flat-shaped wound-electrode group 21 from the solution injection port 11 of the battery cover 10. As the non-aqueous electrolyte, it is possible to use an electrolyte obtained by dissolving lithium hexafluorophosphate (LiPF₆) in a mixed solution, which is obtained by mixing ethylene carbonate (EC) and dimethyl carbonate (DMC) at a volume ratio of 1:2, at concentration of 1 mol/liter.

FIG. 1 is a perspective view of the flat-shaped wound-electrode group of the lithium ion secondary battery which is an embodiment of the present invention, and illustrates a state in which a winding-termination end portion is developed for describing the structure.

The flat-shaped wound-electrode group 21 is formed by winding a positive electrode 1 and a negative electrode 1 in a superimposed manner in a flat shape. Separators 3 and 4 are interposed between the positive electrode 1 and the negative electrode 2 of the flat-shaped wound-electrode group 21 so as to insulate the positive electrode 1 from the negative electrode 2. The separator 4 is wound around an outermost periphery of the flat-shaped wound-electrode group 21, and a winding-termination end portion of the separator 4 is fixed using an adhesive tape or the like so as to prevent unwinding (not illustrated).

The positive electrode 1 has a positive electrode collector made of a metal foil having a constant width, a positive electrode mixture layer 1a which is partially formed on a top surface of the positive electrode collector, and the uncoated portion 1b from which the top surface of the positive electrode collector is exposed. The positive electrode mixture layer 1a is formed by coating a part of the top surface of the positive electrode collector with a positive electrode mixture, and the uncoated portion 1b is formed by exposing the positive electrode collector by not coating a part of the positive electrode collector with the positive electrode mixture. The positive electrode mixture layer 1a is formed at both surfaces of the positive electrode collector, that is, the top surface at one side and the top surface at the other side of the positive electrode collector, and has a constant thickness. The uncoated portion 1b is formed so as to extend along one long side of the positive electrode collector with a constant width. An insulating layer 5 is formed at a boundary portion between the positive electrode mixture layer 1a and the uncoated portion 1b. A detailed configuration of the insulating layer 5 will be described later.

The negative electrode 2 has a negative electrode collector made of a metal foil having a constant width, a negative electrode mixture layer 2a which is partially formed by coating a top surface of the negative electrode collector with a negative electrode mixture, and the uncoated portion 2b from which the negative electrode collector is exposed. The negative electrode mixture layer 2a is formed by coating a part of the top surface of the negative electrode collector with the negative electrode mixture, and the uncoated portion 2b is formed by exposing the negative electrode collector by not coating a part of the negative electrode collector with the negative electrode mixture. The negative electrode mixture layer 2a is formed at both surfaces of the negative electrode collector, that is, the top surface at one side and the top surface at the other side of the negative electrode collector, and has a constant thickness. The uncoated portion 2b is formed so as to extend along one long side of the negative electrode collector with a constant width.

The negative electrode 2 has a length in a long-side direction (winding direction) longer than that of the positive electrode 1. The flat-shaped wound-electrode group 21 has a configuration in which winding is started such that the negative electrode 2 is disposed at an inner peripheral side (center side in the winding axis) than the positive electrode 1, and the winding is terminated such that the negative electrode 2 is disposed at an outer peripheral side than the positive electrode 1. The negative electrode mixture layer 2a of the negative electrode 2 has a width in a short-side direction (the axial direction of winding) larger than that of the positive electrode mixture layer 1a. The flat-shaped wound-electrode group 21 is configured such that the positive electrode 1 is sandwiched by the negative electrode 2, and further, is wound so as to dispose both end portions in the short-side direction of the negative electrode mixture layer 2a at positions protruding to an outer side in the width direction than both end portions in the short-side direction of the positive electrode mixture layer 1a, and the negative electrode mixture layer 2a of the negative electrode 2 oppose the entire surface of the positive electrode mixture layer 1a of the positive electrode 1.

The positive electrode 1 and the negative electrode 2 are wound in the superimposed state such that the respective uncoated portions 1b and 2b are disposed at one side and the other side in the short-side direction, and the separators 3 and 4 are interposed therebetween. The separators 3 and 4 are configured using a microporous film made of a synthetic resin material, for example, polyethylene or the like, having an insulating property. The separators 3 and 4 are interposed at positions at which the positive electrode mixture layer 1a and the negative electrode mixture layer 2a oppose each other, and insulate the positive electrode 1 from the negative electrode 2.

Next, a description will be made in detail regarding a configuration of the positive electrode, which is a characteristic configuration of the present invention.

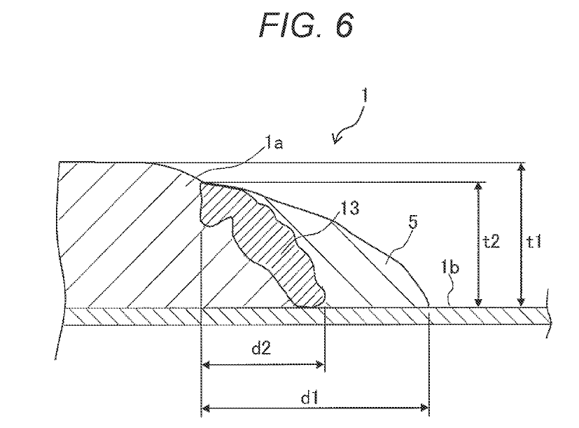

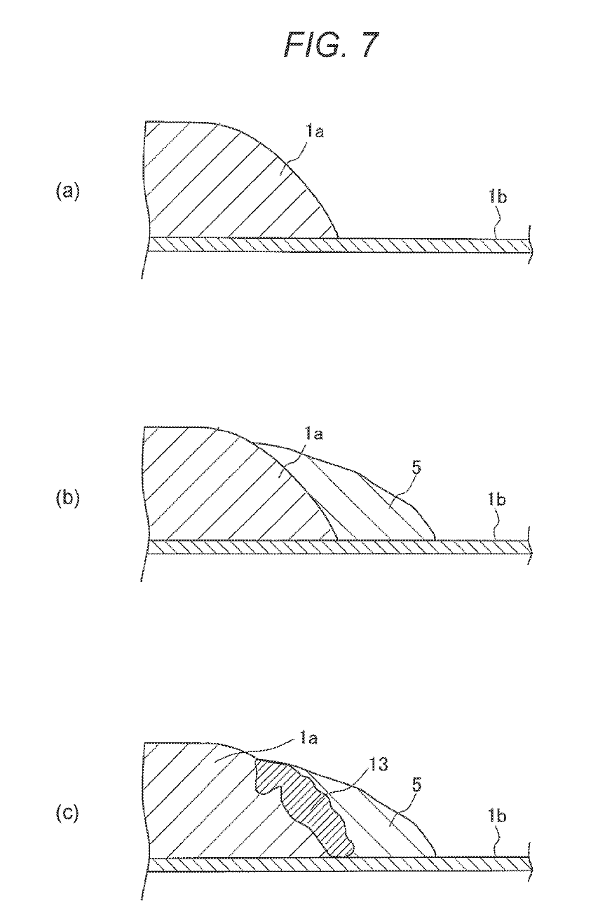

FIG. 5 is a schematic view illustrating a main portion of the positive electrode in cross-section, FIG. 6 is a schematic cross-sectional view describing a configuration of the electrode mixture layer and the insulating layer and the mixed layer of the positive electrode, and FIGS. 7(a) to 7(c) are diagrams describing a method by which the mixed layer is formed.

The positive electrode 1 has a positive electrode mixture layer 1a, which is a mixture coated portion formed on the top surface of the positive electrode collector, and the insulating layer 5 formed on the top surface of the positive electrode collector along an end portion of the positive electrode mixture layer 1a. Further, a mixed layer 13, which is formed by mixing of the positive electrode mixture of the positive electrode mixture layer 1a and an insulator of the insulating layer 5, is interposed between the positive electrode mixture layer 1a and the insulating layer 5.

The positive electrode mixture layer 1a is formed by coating the top surface of the positive electrode collector with the slurry-like positive electrode mixture (positive electrode mixture slurry). As illustrated in FIG. 7(a), the end portion of the positive electrode mixture layer 1a has an inclined surface having a thickness gradually decreasing. The inclined surface is formed when a viscosity of the positive electrode mixture slurry at the time of coating the positive electrode collector with the positive electrode mixture slurry is low so that the positive electrode mixture slurry is spread toward the uncoated portion 1b side until being fixed as liquid is volatilized.

The insulating layer 5 is disposed by coating in tandem with coating of the positive electrode mixture slurry at timing before drying the electrode in contemplation of formation of the mixed layer 13. The insulating layer 5 is formed by applying the slurry-like insulator (insulator slurry) along the end portion of the positive electrode mixture layer 1a. The insulator slurry is applied before the positive electrode mixture slurry of the positive electrode mixture layer 1a is dried. As illustrated in FIG. 7 (b), the insulator slurry is applied along the boundary portion between the positive electrode mixture layer (the mixture coated portion) 1a and the uncoated portion 1b. The insulator slurry is coated on the top surface of the positive electrode collector so as to be superimposed on the inclined surface of the positive electrode mixture layer 1a.

The insulating layer 5 has an opposing surface which oppositely abuts on the inclined surface of the positive electrode mixture layer 1a. The opposing surface is formed by applying the insulator slurry so as to be superimposed on the end portion of the positive electrode mixture layer 1a. As illustrated in FIG. 6, the insulator slurry is applied such that a thickness t2 of the insulating layer 5 is equal to or smaller than a thickness t1 of the positive electrode mixture layer 1a. A thickness t2 of the mixed layer 13 is equal to or smaller than a thickness t1 of the portion in which the positive electrode mixture layer 1a is formed (t2≦t1). The insulator configuring the insulating layer 5 has an insulating material such as metal oxide having a particle diameter of, for example, equal to or smaller than 1 μm, and a solvent-based binder such as PVdF or an epoxy resin.

As illustrated in FIG. 7(c), the mixed layer 13 is provided to be interposed between the inclined surface of the positive electrode mixture layer 1a and the opposing surface of the insulating layer 5, and there is no gap between the positive electrode mixture layer 1a and the insulating layer 5. The mixed layer 13 is formed by applying the insulator slurry of the insulating layer 5 before the positive electrode mixture slurry of the positive electrode mixture layer 1a is so as to secure a mixing time set in advance before entering a drying furnace. That is, the mixed layer 13 is formed when an undried positive electrode mixture of the positive electrode mixture layer 1a and an undried insulator of the insulating layer 5 are mixed with each other between the inclined surface and the opposing surface during a predetermined mixing time.

A solid content of the positive electrode mixture slurry is preferably in a range of equal to or higher than 50 wt % and equal to or lower than 70 wt %, and more preferably, in a range of equal to or higher than 60 wt % and equal to or lower than 70 wt %. A solid content of the insulator slurry, with which the favorable mixed layer 13 can be formed with respect to the positive electrode mixture slurry having the solid content in such a range, is preferably equal to or higher than 20 wt % and equal to or lower than 50 wt %.

In a case where the solid content of the insulator slurry is less than 20 wt % at the time of forming the mixed layer, an impregnation degree to the positive electrode mixture layer 1a increases, and a function of serving as the insulating layer 5 is degraded. On the other hand, in a case where the solid content of the insulator slurry is higher than 50 wt %, the mixed layer 13 with the positive electrode mixture layer 1a is insufficiently formed, and thus, it is difficult to secure adhesion strength.

It is possible to mix the positive electrode mixture of the positive electrode mixture layer 1a and the insulator of the insulating layer 5 at the boundary between the inclined surface and the opposing surface by using the positive electrode mixture slurry and the insulator slurry each having the solid content in the above-described preferable range, and it is possible to form the mixed layer 13 capable of obtaining an anchor effect, which is sufficient adhesion strength of the insulating layer 5 with respect to the positive electrode mixture layer 1a. The adhesion strength of the insulating layer 5 is secured by forming the mixed layer 13. In addition, it is possible to avoid generation of an internal short-circuit without generation of the gap between the positive electrode mixture layer 1a and the insulating layer 5.

A width d2 of the mixed layer 13 is preferably equal to or larger than 30 μm and equal to or smaller than 100 μm. In addition, the mixed layer 13 is formed in an inclined portion provided in the positive electrode mixture layer 1a. It is possible to secure a peeling strength of the insulating layer 5 and to prevent generation of the gap between the insulating layer 5 and the positive electrode mixture layer 1a by perform control in the above-described range. In addition, a maximum thickness t2 of the insulating layer 5 does not exceed a maximum thickness t1 of the positive electrode mixture layer 1a, and it is possible to eliminate a bulge (convex portion) in the mixed layer 13, and to avoid failure such as winding displacement at the time of electrode processing or assembly.

As a range in which the mixed layer 13 exhibits the sufficient anchor effect, a mixing degree (ratio) between the positive electrode mixture and the insulator in the mixed layer 13 is preferably equal to or higher than 70% (equal to or higher than 70% of the positive electrode mixture and the insulator are mixed). When the mixing degree is equal to or higher than 70%, it is possible to reliably secure the anchor effect.

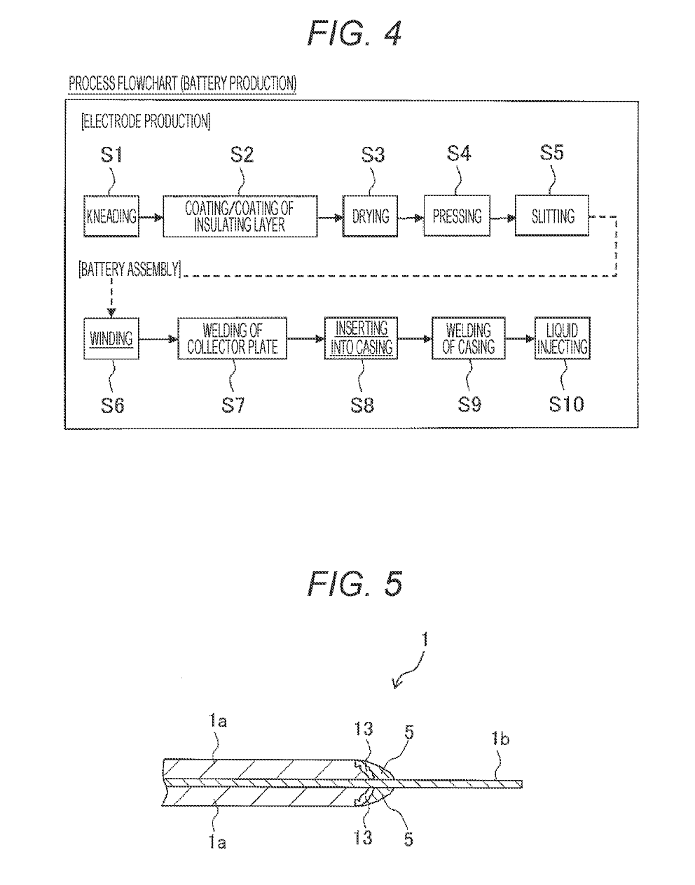

FIG. 4 is a flowchart of a battery manufacturing process of the lithium ion secondary battery which is an embodiment of the present invention. In regard to producing an electrode, kneading S1, coating S2, drying S3, pressing S4, and slitting S5 are performed in the order, thereby producing an electrode raw sheet.

In the kneading S1, an active material, a conductive aid and a binder are mixed in a predetermined weight ratio, and then, a dispersion solvent is added to the resultant thereby producing the electrode mixture slurry adjusted to have a predetermined solid concentration and viscosity. In the coating S2, both surfaces of a metal foil substrate having a predetermined thickness are coated with the mixture slurry by a predetermined width and a predetermined weight. Further, in the case of the positive electrode, the coating of the insulator slurry of the insulating layer 5 is performed in tandem with the coating S2. The coating of the insulator slurry is performed before the positive electrode mixture slurry of the positive electrode mixture layer 1a is dried.

Further, the drying S3 is performed after the mixing time set in advance elapses after the coating of the insulator slurry. It is possible to promote the mixing of the positive electrode mixture of the positive electrode mixture slurry and the insulator of the insulator slurry, and to form the mixed layer 13 having a suitable thickness d2 by providing the mixing time set in advance after the coating of the insulator slurry before the drying S3. Further, only the solvent is removed by the drying S3, thereby producing a coating-completed electrode.

In the pressing S4, the coating-completed electrode is compressed to have a predetermined thickness by roll press, thereby producing a pressed electrode having a predetermined electrode density. In the slitting S5, the pressed electrode is cut so as to have a predetermined coated portion width, and a predetermined uncoated portion width, thereby producing the electrode raw sheet.

Thereafter, the lithium ion secondary battery 22 is produced using the electrode raw sheet via respective steps of winding S6, welding of a collector plate S7, inserting into a casing S8, welding of a casing S9, and liquid injecting S10. In the winding S6, the positive electrode 1 and the negative electrode 2 are wound with the separators 3 and 4 interposed therebetween such that both the electrode are not in direct contact with each other, thereby producing the flat-shaped wound-electrode group 21. Both the electrodes may be wound together using a winding axis depending on cases. In addition, the preparation is performed by winding the positive electrode uncoated portion 1b and the negative electrode uncoated portion 2b so as to be disposed at end portions opposite to each other of the flat-shaped wound-electrode group 21, that is, to be separated at one side and the other side in the axial direction of winding while performing meandering control such that each electrode end surface and a separator end surface are at constant positions.

In the present embodiment, the maximum thickness t2 of the insulating layer 5 is set to be equal to or smaller than the maximum thickness t1 of the positive electrode mixture layer 1a, and thus, it is possible to prevent the mixed layer 13 from bulging than the positive electrode mixture layer 1a and forming the convex portion. Accordingly, it is possible to avoid the failure such as the winding displacement at the time of electrode processing or assembly.

In the welding of a collector plate S7, the positive electrode collector plate 7 and the negative electrode collector plate 6 are bonded, respectively, to the positive electrode uncoated portion 1b and the negative electrode uncoated portion 2b which are positioned at the end portions opposite to each other of the flat-shaped wound-electrode group 21 using ultrasonic welding. In addition, the positive electrode collector plate 7 and the negative electrode collector plate 6 are connected, respectively, to the positive electrode external terminal 9 and the negative electrode external terminal 8 in preset portions of the battery cover 10.

In the inserting into a casing S8 and the subsequent welding of a casing S9, the flat-shaped wound-electrode group 21 attached with a cover portion including the positive electrode collector plate 7 and the negative electrode collector plate 6 is inserted into the battery container 12, and the battery cover 10 and the battery container 12 are sealed using laser welding. In the liquid injecting, a predetermined amount of the non-aqueous electrolyte is injected into the battery container 12 through the solution injection port 11 provided in the cover portion, and then, the solution injection port 11 is sealed using laser welding, thereby producing the lithium ion secondary battery 22.

The present invention is not limited to the above-described embodiment. Although the PVdF has been exemplified as the binder, any polymer of, for example, polytetrafluoroethylene (PTFE), polyethylene, polystyrene, polybutadiene, butyl rubber, nitrile rubber, styrene-butadiene rubber, polysulfide rubber, nitrocellulose, cyanoethylcellulose, various kinds of latex, acrylonitrile, vinyl fluoride, vinylidene fluoride, propylene fluoride, chloroprene fluoride or the like, and a mixture thereof may be used as the binder.

In addition, although the non-aqueous electrolyte, obtained by dissolving LiPF₆ in the mixed solution of ethylene carbonate (EC) and dimethyl carbonate (DMC), has been exemplified in the present invention, a non-aqueous electrolyte obtained by dissolving a general lithium salt as an electrolyte in an organic solvent may be used, and the present invention is not particularly limited to the lithium salt or the organic solvent to be used. For example, it is possible to use LiClO₄, LiAsF₆, LiBF₄, LiB(C₆H₅)₄, CH₃SO₃Li, CF₃SO₃Li and the like, or a mixture thereof as the electrolyte. In addition, any one of propylene carbonate, ethylene carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methylsulfolane, acetonitrile, propionitrile, and the like, or a solvent mixture containing two or more types thereof may be used as the organic solvent, and a blending ratio of the mixture is not limited.

Next, a description will be made regarding Examples of the prismatic lithium ion secondary battery 22 produced according to the above-described embodiment.

### Example 1

### Electrode Production (Positive Electrode)

Both surfaces of an aluminum foil having a thickness of 20 μm, to be the positive electrode collector, were coated with a slurry obtained by mixing lithium transition metal composite oxide as a positive-electrode active material, flake graphite as the conductive aid, and polyvinylidene fluoride (PVdF) as the binder in a weight ratio of 85:10:5, and adding and kneading N-methylpyrrolidone (NMP) as the dispersion solvent to the resultant. The positive electrode mixture layer 1a was coated under conditions of a width of 80 mm, and a coated amount of 130 g/m². In tandem with this, the insulating layer 5 was coated in the vicinity of the boundary with one of the uncoated portions thereof.

The insulating layer 5 was coated using a slurry having a solid content of 30 wt % and obtained by dispersing alumina powder having a particle diameter of 0.8 μm as the insulating material in a solution obtained by dissolving PVdF in NMP. Further, the mixed layer 13 was formed between the positive electrode mixture layer 1a and the insulating layer 5 by allowing the resultant to stand for a predetermined mixing time before entering the drying furnace. The width d2 (see FIG. 6) of the mixed layer 13 to be formed between the positive electrode mixture layer 1a and the insulating layer 5 was set to 50 μm.

The adhesion strength between the insulating layer 5 and the positive electrode mixture layer 1a is secured by the formation of the mixed layer 13. In addition, it is possible to avoid the generation of the internal short-circuit without generation of the gap between the positive electrode mixture layer 1a and the insulating layer 5. The mixed layer 13 was formed on the inclined portion provided in the positive electrode mixture layer 1a.

Thereafter, the mixture layer 1a, the insulating layer 5 and the mixed layer 13 were dried in the drying furnace, and then subjected pressing and cutting, thereby obtaining the positive electrode 1 having a width of the positive electrode mixture layer 1a of 80 mm, a coated amount of 130 g/m², and an electrode length of 4 m. The uncoated portion 1b continuously formed was disposed in the end portion at one side in a longitudinal direction of the aluminum foil, and this portion was set as a positive electrode lead.

<Electrode Production (Negative Electrode)>

Both surfaces of a copper foil having a thickness of 10 to be the negative electrode collector, were coated with a slurry obtained by adding graphite carbon powder as a negative-electrode active material and PVdF as the binder, and adding and kneading NMP as the dispersion solvent to the resultant. Thereafter, the resultant was subjected to drying, pressing and cutting, thereby obtaining the negative electrode 2 having a width of the negative electrode mixture layer 2a of 84 mm, a coated amount of 70 g/m², and an electrode length of 4.4 m. Incidentally, the uncoated portion 2b continuously formed was disposed in the end portion at one side in a longitudinal direction of the copper foil, and this portion was set as a negative electrode lead.

<Battery Assembly>

The positive electrode 1 and the negative electrode 2 produced as above were wound together with the microporous separators 3 and 4, made of polyethylene to have a width of 90 mm, and a thickness of 30 μm, so as to prevent both the electrodes from being in direct contact with each other, thereby producing the flat-shaped wound-electrode group 21. The flat-shaped wound-electrode group 21 was produced while performing the meandering control such that the electrode end surfaces and the separator end surface are at constant positions while extending all the positive electrode 1, the negative electrode 2, the separator 3 and the separator 4 in the longitudinal direction by applying a load of 10 N. One or more layers of the separator 3 and the separator 4 were disposed at the center of the flat-shaped wound-electrode group 21. At this time, the positive electrode uncoated portion 1b and the negative electrode uncoated portion 2b were allowed to be positioned, respectively, at the end portions opposite to each other of the flat-shaped wound-electrode group 21.

Next, the negative electrode external terminal 8 and the positive electrode external terminal 9 were produced so as to be connected, in advance, to the battery cover 10 provided with the solution injection port 11 so as to electrically conduct the negative electrode external terminal 8 with the negative electrode collector plate 6, and electrically conduct the positive electrode external terminal 9 with the positive electrode collector plate 7. The positive electrode uncoated portion 1b was bonded to the positive electrode collector plate 7 using ultrasonic welding, the negative electrode uncoated portion 2b and the negative electrode collector plate 6 were also bonded to each other in the same manner. Thereafter, the flat-shaped wound-electrode group 21 attached with the battery cover portion was inserted into the battery container 12.

A predetermined amount of the non-aqueous electrolyte capable of infiltrating into the entire flat-shaped wound-electrode group 21 was injected into the battery container 12 through the solution injection port 11, and then, the solution injection port 11 was sealed, thereby completing the lithium ion secondary battery 22. The electrolyte obtained by dissolving lithium hexafluorophosphate (LiPF₆) in the mixed solution, which is obtained by mixing ethylene carbonate and dimethyl carbonate at the volume ratio of 1:2, at concentration of 1 mol/liter was used as the non-aqueous electrolyte. The solution injection port 11 was sealed by laser welding, thereby producing the lithium ion secondary battery 22.

### Example 2

The lithium ion secondary battery 22 according to Example 2 has the same configuration as the lithium ion secondary battery 22 that has been described in Example 1 except only for the insulating layer 5. Accordingly, a description will be made only regarding the insulating layer 5.

<Electrode Production (Positive Electrode)>

The insulating layer 5 was produced in the same manner as Example 1 except that a solution obtained by dissolving NMP in a mixture of a bisphenol A type epoxy resin and an acrylic acid copolymer was applied. Any epoxy resin other than the above-described type may be used.

The lithium ion secondary battery 22 was produced in the same manner as Example 1 except for such a difference.

As illustrated in FIG. 6, the mixed layer 13 is formed in the positive electrode 1 produced in Examples 1 and 2, and thus, the adhesion strength is sufficiently secured, and further, it is possible to avoid the concern of the internal short-circuit without generation of the gap between the positive electrode mixture layer 1a and the insulating layer 5. In an internal short-circuit test of a battery produced using the above-described positive electrode, a sufficient resistance is obtained, and accordingly, it is considered that the present invention is advantageous.

As described above, although the embodiment of the present invention has been described in detail, the present invention is not limited to the above-described embodiment, and various types of design alteration can be performed in a range of not departing from a spirit of the present invention described in claims. For example, the embodiment has been described in detail for describing the present invention in an easily understandable manner, and it is not limited to an embodiment necessarily including the entire configuration described above. In addition, a part of the configuration of a specific embodiment can be replaced with the configuration of another embodiment, and the configuration of another embodiment may be added to that of a specific embodiment. Furthermore, addition, deletion, replacement, with the use of another configuration, may be applied to part of the configuration of each of the embodiments.

### REFERENCE SIGNS LIST

1 positive electrode
1a positive electrode mixture layer
1b positive electrode uncoated portion
2 negative electrode
2a negative electrode mixture layer
2b negative electrode uncoated portion
3 separator
4 separator
5 insulating layer
6 negative electrode collector plate
7 positive electrode collector plate
8 negative electrode external terminal
9 positive electrode external terminal
10 battery cover
11 solution injection port
12 battery casing
13 mixed layer
21 flat-shaped wound-electrode group
22 lithium ion secondary battery

1. A lithium ion secondary battery comprising an electrode group in which a separator is interposed between a positive electrode and a negative electrode, wherein
the positive electrode has a positive electrode collector, a positive electrode mixture layer formed on a top surface of the positive electrode collector, and an insulating layer formed on the top surface of the positive electrode collector along an end portion of the positive electrode mixture layer,
a mixed layer, formed by mixing of a positive electrode mixture configuring the positive electrode mixture layer, and an insulator configuring the insulating layer, is interposed between the positive electrode mixture layer and the insulating layer, and
the insulating layer is formed by applying an insulator slurry that has an insulating material and a solvent-based binder with a solid concentration of equal to or higher than 20 wt % and equal to or lower than 50 wt %.

2. The lithium ion secondary battery according to claim 1, wherein
an end portion of the positive electrode mixture layer has an inclined surface having a thickness gradually decreasing,
the insulating layer has an opposing surface that opposes the inclined surface, and
the mixed layer is interposed between the inclined surface and the opposing surface.

3. The lithium ion secondary battery according to claim 1, wherein
a thickness of the insulating layer is equal to or smaller than a thickness of the positive electrode mixture layer.

4. The lithium ion secondary battery according to claim 1, wherein
a width of the mixed layer is equal to or larger than 30 μm and equal to or smaller than 100 μm.

5. (canceled)

6. The lithium ion secondary battery according to claim 1, wherein
the insulating material has metal oxide having a particle diameter of equal to or smaller than 1 μm, and the solvent-based binder has PVdF or an epoxy resin.

7. A method of manufacturing a lithium ion secondary battery including an electrode group in which a separator is interposed between a positive electrode and a negative electrode, the method comprising:
a step of forming a positive electrode mixture layer by coating a top surface of a positive electrode collector with a slurry-like positive electrode mixture;
a step of forming an insulating layer by coating a slurry-like insulator on the top surface of the positive electrode collector along an end portion of the positive electrode mixture layer before the positive electrode mixture of the positive electrode mixture layer is dried; and
a step of performing heating and drying after a mixing time set in advance elapses from the coating of the insulator.
